(19) United States
(12) Patent Application Publication
(10) Pub. No.: US 2008/0046121 A1
(43) Pub. Date: Feb. 21, 2008

(54) Developing system of re-configurable modularized robot

(75) Inventors: Wei-Shen Pao, Hsinchu (TW); Ton-Han Lee, Hsinchu (TW); Chien-I Chang, Hsinchu (TW)

Correspondence Address: BIRCH STEWART KOLASCH & BIRCH, PO BOX 747, FALLS CHURCH, VA, 22040-0747, US

(73) Assignee: INNOVATI, INC.

(21) Appl. No.: 11/505,334

(22) Filed: Aug. 17, 2006

(51) Int. Cl. G06F 19/00

(52) U.S. Cl. 700/245

(57) ABSTRACT

A developing system of re-configurable modularized robot is provided, and it includes a single board computer (SBC) which includes a communication interface used to receive, transmit and download the plurality of commands and responds in the communication of the run-time man-machine interface; and a master micro controller connects with the interface; a transmission unit, it is a three-wire signal transmission center, which is used to transmit the command and signal; and at least one module connects with the transmission unit, and includes a slave micro controllers and a functional unit, the slave micro controller and the functional unit used to execute the command which comes from the master micro controller.

### BACKGROUND OF THE INVENTION

1. Field of the Invention

The present invention relates to a robot modularized system and more especially, relates to a developing system of the re-configurable modularized robots that can even assist hobbyists without electronic background in developing their custom-made robots rapidly, flexibly and easily.

2. Description of the Prior Art

The electronic technologies, such as the communication, navigation and network technology, are progressing rapidly. Modules are made for system integration with less effort. However, most of them are developed to meet the individual industrial and commercial needs and systematic applications for hobbyists are not considered. For example, the micro-controllers communicate with the modules through input/output ports, due to the limited input/output ports resources, the total amount of modules are therefore limited which leads to a limited functionality. The peripheral modules are controlled by the micro-controller to perform their functionality, which increases the program code and work loading of the micro-controllers, which dramatically impact the overall efficiency of the micro-controller systems. Besides, due to the complexity of the system, once the system malfunction happens, debug becomes a tremendous task for hobbyists who lack of relating backgrounds.

### SUMMARY OF THE INVENTION

According to the issue mentioned previously, the present invention provides a developing system of re-configurable modularized robot.

One of objects of this invention is to provide a sophisticated master/salve micro-controller system, which includes a master micro-controller and plurality of slave micro-controllers to communicate and cooperate at the same time. With this reliable scheme, the difficulty of the development of the master/salve micro-controller system is reduced and the functionality of peripheral modules is increased, which leads the accomplishment of the diversified and originative robots.

Another object of this invention is to build in one slave micro-controller in each peripheral module, which executes the commands coming from the master micro-controller. Because the control know-how is built-in within the slave micro-controller of each peripheral module in a totally object-oriented manner, it can dramatically reduce the development difficulty of a robot. The functionality reconfiguration becomes simple and flexible and easy to debug.

Another object of this invention is to provide a 3-wired transmission unit, which is a communication bus allows the master and slave micro-controllers to communication and a plurality of peripheral modules can be connected to the same bus with different module identification settings. The number of modules will no longer be limited to the input/output ports. The feature makes the peripheral modules like building blocks that can be easily and flexibly added to and remove from the system.

Another object of this invention is to provide the event feature, which allows the slave micro-controllers of peripheral modules to automatically report the pre-defined events when they happen to the master micro-controller. With this feature, the master micro-controller can save time in polling the slave micro-controllers and the system loading is therefore much reduced.

Another object of this invention is to provide a run-time human-machine interface in this developing system of the re-configurable modularized robots, which allows the master micro-controller to exchange run-time information with people though PC, which provides the re-configurable modularized robots more human interactive features.

Accordingly, one embodiment of the present invention provides a developing system of re-configurable modularized robot includes a single board computer, having a communication interface used to receive and transmit the plurality of commands and responds in the communication of the run-time man-machine interface, and a master micro-controller connecting with the communication interface to execute the plurality of commands; a transmission unit connecting to the single board computer and used to transmit the plurality of commands and signals in dual way, such as a three-wire transmission interface; and at least one peripheral module connecting to the transmission unit, and every peripheral module has their own slave micro-controller and a functional element connecting to the slave micro-controller.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a system block diagram in accordance with an embodiment of the present invention;

FIG. 2 is a block diagram of the satellite positioning robot structure in accordance with an embodiment of the present invention;

FIG. 3 is schematic block diagram illustrating the frame of the security system in accordance with another embodiment of the present invention;

FIG. 4 is a block diagram of the home application control system structure by remote control in accordance with another embodiment of the present invention; and

FIG. 5 is a flow chart of developing the originative robot in accordance with one embodiment of the present invention.

### DETAILED DESCRIPTION OF THE INVENTION

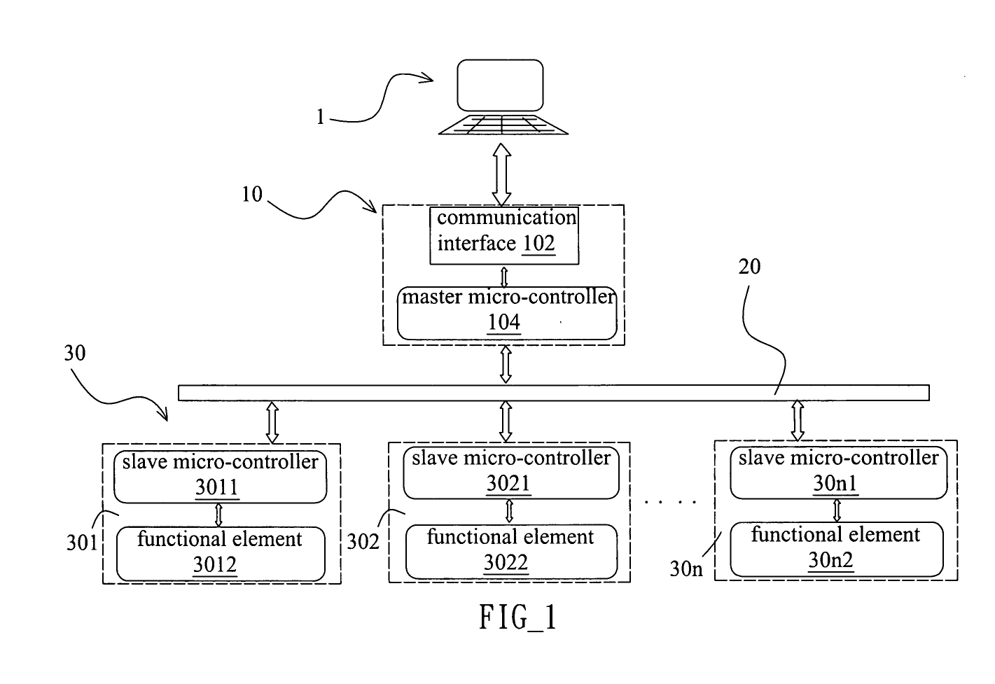

Please referring to FIG. 1, is a schematic block diagram in accordance with an embodiment of the present invention. The developing system of re-configurable modularized robot includes a single board computer (SBC) 10 electrically communicated with one or more peripheral module sets 30 via a transmission unit 20. For the SBC 10, a master micro-controller 104 receives commands from a computer 1 via a communication interface 102, such as a universal serial bus (USB) with a built-in USB controller, an IEEE 1394, an IR, any peripheral interface bus, or a serial interface bus. Furthermore, the communication interface 102 may respond in the communication of interior or exterior run-time man-machine interface (not shown in the figure), the run-time man-machine interface allows the master micro-controller 104 to exchange run-time information with people through computer 1, which provides the re-configurable modularized robots more human interactive features.

Next, the peripheral module set 30 includes a plurality of peripheral modules 301, 302, . . . , and 30n. In one embodiment, the peripheral module 301, 302, . . . , and 30n may include respective functional elements 3012, 3022, . . . and 30n2, and respective corresponding slave micro-controller 3011, 3021, . . . and 30n1 coupled each other. The slave micro-controllers 3011, 3021, . . . , and 30n1 are used as a communication interface between the SBC 10 and the corresponding functional elements 3012, 3022, . . . , and 30n2, execute the commands from the SBC 10, and ensure the correct execution of the corresponding functional elements 3012, 3022, . . . , and 30n2. Besides, each of peripheral modules 301, 302, . . . , and 30n further include a switch (not shown) used to identify the identification code of each peripheral module 301, 302, . . . , and 30n. Each switch exploits a plurality of bits to identify the identification code, and each bit may identify two identification codes, said, the amount of the identification code is 2ⁿ. The SBC 10 utilizes the identification code to identify the corresponding peripheral modules 301, 302, . . . , and 30n when the SBC 10 would like to command the peripheral module set 30. Understandable, more peripheral modules used, more bits of the switch is needed.

Furthermore, the transmission unit 20, which is both connected to the master micro-controller 104 of the SBC 10 and the slave micro-controllers 3011, 3021, . . . , and 30n1, may be a three-wire command bus including a data line, a clock line and an event line (not shown in the figure). In one embodiment, the data line and the clock line are used to transmit the commands from the master micro-controller 104 or to access data. The event line is used to send signals back to the master micro-controller 104. The event line allows the slave micro-controller 3011, 3021, . . . , and 30n1 of peripheral modules 301, 302, . . . , and 30n to automatically report the pre-defined events when the happen to the master micro-controller 104. An event signal may be sent to the SBC 10 through the event line of the transmission unit 20. In the meantime, the SBC 10 may accesses the data from the slave micro-controllers 3011, 3021, . . . , and 30n1 of the peripheral modules 301, 302, . . . , and 30n through the data line and the clock line of the transmission unit 20. Accordingly, the transmission unit 20 allows the master micro-controller 104 and slave micro-controllers 3011, 3021, . . . , and 30n1 to communication and a plurality of peripheral modules 301, 302, . . . , and 30n can be connected to the same bus with different module identification setting, and the master micro-controller 104 can save time in polling the slave micro-controllers 3011, 3021, . . . , and 30n1 and the system loading is reduced.

In this embodiment, the developing system of re-configurable modularized robot provides a product developer with software in the computer 1 to easily edit simply high-level language program. While the program compiling is completed, a command may be downloaded from the computer 1 to the master micro-controller 104 of the SBC 10 through the communication interface 102. The command may be transmitted to the slave micro-controller 3011, 3021, . . . , and 30n1 of the peripheral module set 30 through the transmission unit 20 after the master micro-controller 104 completely processes the command. The slave micro-controllers 3011, 3021, . . . , and 30n1 in response to the command will control the corresponding functional elements 3012, 3022, . . . , and 30n2 to execute the function by request of the product developer.

Accordingly, the master micro-controller 104 just commands the slave micro-controllers 3011, 3021, . . . , and 30n1, instead of direct control on all functional elements 3012, 3022, . . . , and 302n2. Thus, the slave micro-controllers 3011, 3021, . . . , and 30n1 in response to the command control the functional elements 3012, 3022, . . . , and 30n1. Accordingly, the loading of the master micro-controller 104 may be efficiently reduced. It is noted that when the SBC 10 communicates with the peripheral module set 30, the transmission unit 20 just services one peripheral module (301, 302, . . . , or 30n) at a time and in FIFO (first in, first out) sequence in request of use.

Thus, the developing system of the re-configurable modularized robot to build in one slave micro-controller in each peripheral module, which executes the commands coming from the master micro-controller. Moreover, the master micro-controller communicates with the plurality of slave micro-controllers via a transmission unit. Wherein the transmission unit may be a three-wire transmission interface to transmit data and clock signals and send the status or the real time information of the peripheral module back to the master micro-controller. Because the control know-how is built-in within the slave micro-controller of each peripheral module in a totally object-oriented manner, the master micro-controller may control the plurality of peripheral modules to communicate and cooperate at the same time, with this reliable scheme, the difficulty of the development of the master/slave micro-controller system is reduced, the functionality of peripheral modules is increased, and dramatically reduce the system loading when pooling the peripheral modules. Furthermore, it leads the accomplishment of the diversified and originative robots. Next, there are some applications in accordance with the present invention as follows.

According to the spirit of the present invention, the application of the developing system of re-configurable modularized robot may the product developer with choosing the different functional elements for different application fields to allocate the SBC and the transmission unit to achieve the diverse applications of the SBC and the functional elements. For example, the functional element may be an output element (such as the Light Emitting Diode, Liquid Crystal Display, the Organic Light Emitting Diode, the Vacuum Fluorescent Display, and the seven-segment Display), an input element (such as the keyboard, the joystick, the knob, the touch panel, and the mouse), a motive power element (such as the motor, the proportional-integral-derivative, and the servo driver), a network element (such as the Ethernet, the Webserver, and the X-ten), a storage element (such as the flash memory, the electrically erasable and programmable read only memory, and the digital security card), a vocal element (such as the speech element, the voice recognition element, the text-to-speech element, and the synthesizer element), an image element (such as the image recognition element and the color recognition element), a Fuzzy algorithm element, a communication element (such as the radio frequency identification element, the infrared element, the radio frequency element, the infrared data association element, the Zigbee element, the RS-232, the I²C, the general packet radio service element, the modem, the universal serial bus, the bluetooth element, the code division multiple access element, the global system for mobile communication element, the RS 422/485, and the telecom), a sensor element (such as the temperature sensor, the press sensor, the motion sensor, the humidity sensor, the ultrasonic ranger finder, and the IR ranger finder), a navigation element (such as the global positioning system, the accelerator, the electronic compass element, the gyro), an AM/FM radio element, a relay, an analog to digital converter, and a time piece.

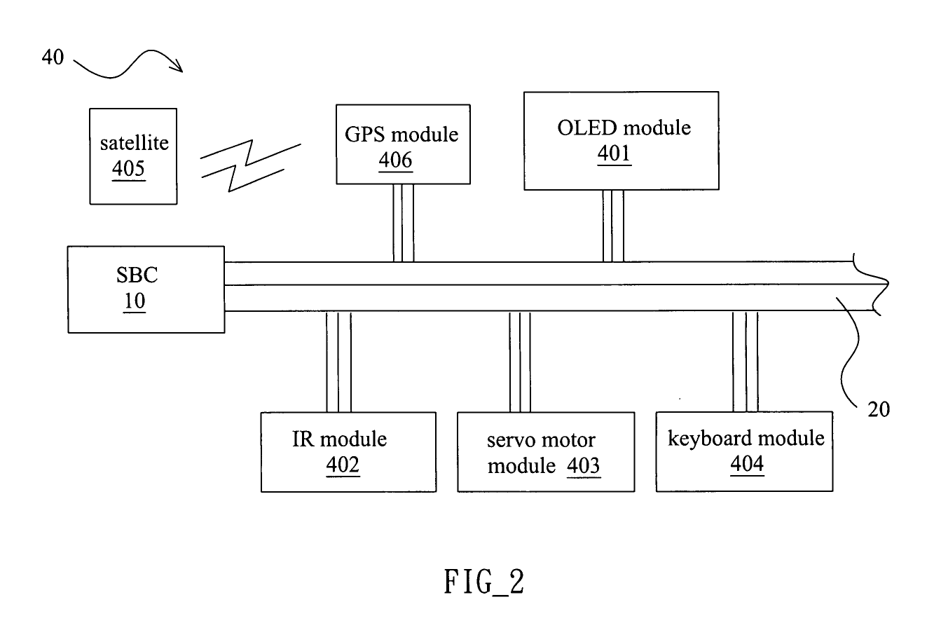

Please referring to FIG. 2, is a block diagram illustrating application to the satellite positioning robot structure in accordance with an embodiment of the present invention. Shown in FIG. 2, the satellite positioning robot 40 includes an SBC 10 communicated with a global positioning system (GPS) module 406 which is used to receive the signal from a satellite 405, an organic light emitting diode (OLED) module 401, an infrared (IR) module 402, a servo motor module 403, and a keyboard module 404 via a transmission unit 20. The commands or the event signals may be transmitted between the SBC 10 and the OLED module 401, the IR module 402, the servo motor module 403, and a keyboard module 404 through the transmission unit 20. Furthermore, the OLED module 401, the IR module 402, the servo motor module 403, and the keyboard module 404 all have their own slave micro-controller (3011, 3021, . . . , 30n1, shown in FIG. 1) respectively to receive and to process the command from the SBC 10 and control the corresponding functional elements (such as OLED, GPS, IR . . . etc).

On application, the satellite positioning robot 40 exploits the keyboard module 404 to setup the location of the destination, while the GPS module 406 gets the location coordinates from the satellite signal, and transmits the coordinates value back to the SBC 10 through the transmission unit 20. Next, the SBC 10 commands the servo motor 403 to move the satellite positioning robot 40 to a default position and the OLED module 401 displays the current coordinates of the satellite positioning robot 40. The IR module 402 may detect whether any barricade exists on the robot-moving route or not at the same time. Once the IR module 402 detects a barricade on the robot-moving route, the IR module 402 will send a signal back to the SBC 10 though the event line (not shown) of the transmission unit 20 to notice the SBC 10 about the coordinates of the barricade. Then, the SBC 10 will correct the moving route of the satellite positioning robot 40 immediately and command the servo motor module 403 to drive the satellite positioning robot 40 to move.

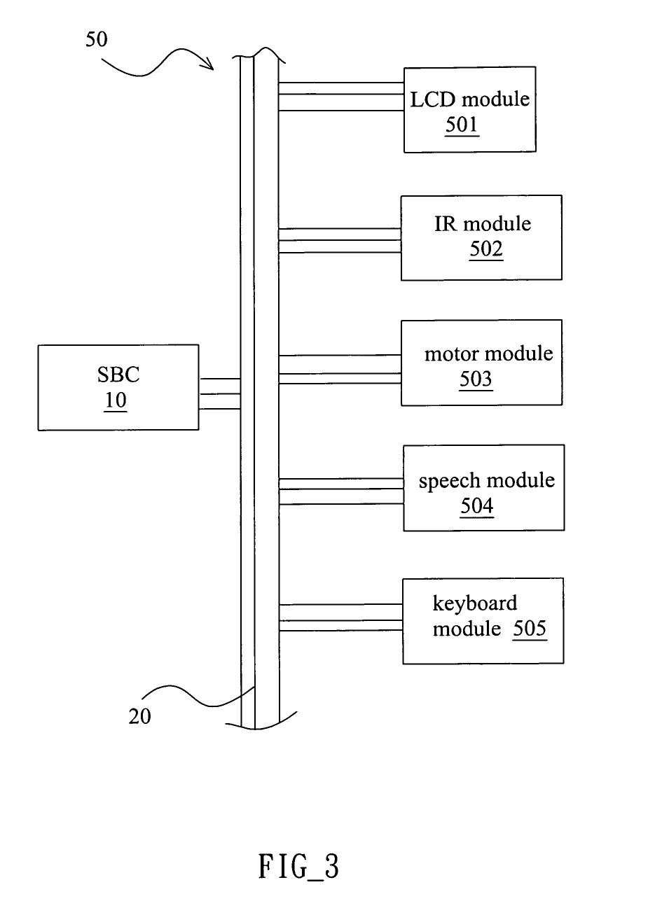

Please referring to FIG. 3, is a schematic block diagram illustrating another application to a security system in accordance with another embodiment of the present invention. The security system 50 includes an SBC 10, a liquid crystal display (LCD) module 501, an IR module 502, a motor module 503, a speech module 504, and a keyboard module 505; all modules are connected with the SBC 10 via the transmission unit 20 and interlink to the whole security system 50. Similar to the application aforementioned, all of the modules have their respective slave micro-controllers to receive and process the command which comes from the SBC 10 and control the corresponding functional elements. On application, when someone approaches to the area protected by the security system 50 and is detected by the IR module 502, the IR module 502 may notify the SBC 10 of the event by the transmission unit 20. At the meantime, the SBC 10 commands the speech module 504 to alarm in response to the distance between the invader and the IR module 502 within the guarded area and asks the invader for a password. The key-in number password may be transmitted from the keyboard module 505 to the SBC 10 and then shown on the LCD module 501 through the transmission unit 20. Moreover, the key-in number password may be further identified. The SBC 10 commands the motor module 503 to unlock the door in response to the valid key-in number password. Otherwise, the SBC 10 commands the speech module 504 to alarm and ask the invader to enter the password again in order to achieve the security purpose.

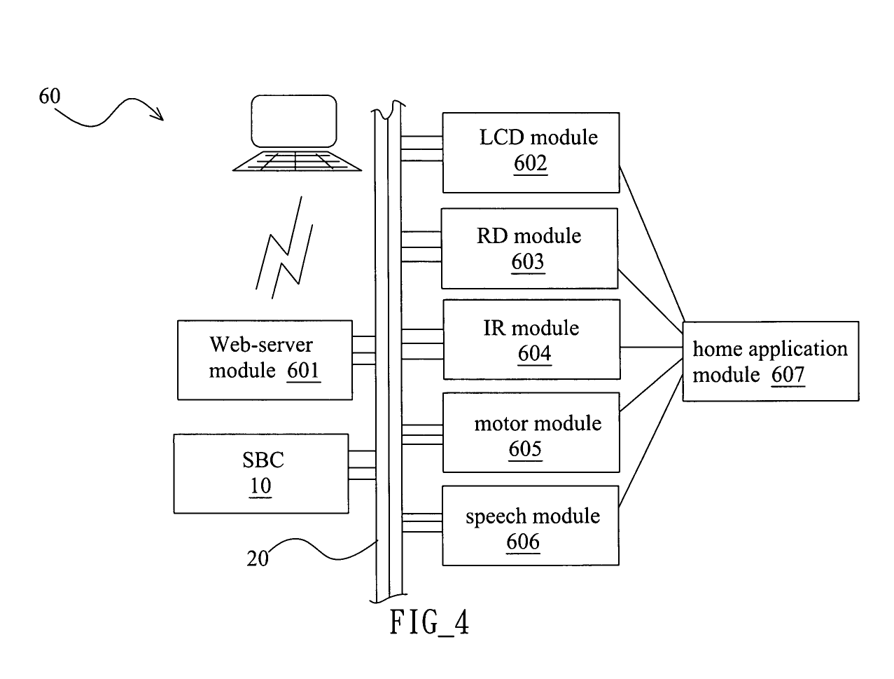

Please referring to FIG. 4, is a block diagram of another application to the home application control system structured by remote control in accordance with another embodiment of the present invention. The home application control system 60 includes an SBC 10 communicated with a web-server module 601, an LCD module 602, a radio frequency (RF) module 603, an IR module 604, a motor module 605, a speech module 606, and a home application module 607 via the transmission unit 20. On application, the home application control system 60 may link to the Internet and the user instructs the command on the website, the web-server passes the information or the commands from the Internet to the SBC 10 through the transmission unit 20. The SBC 10 will display the information or the command on the LCD module 602 immediately, or drive the speech module 606 to alarm and remotely control the home application module 607 via the RF module 603 or the IR module 604, such as to enable the cooker or the air conditioner . . . etc.

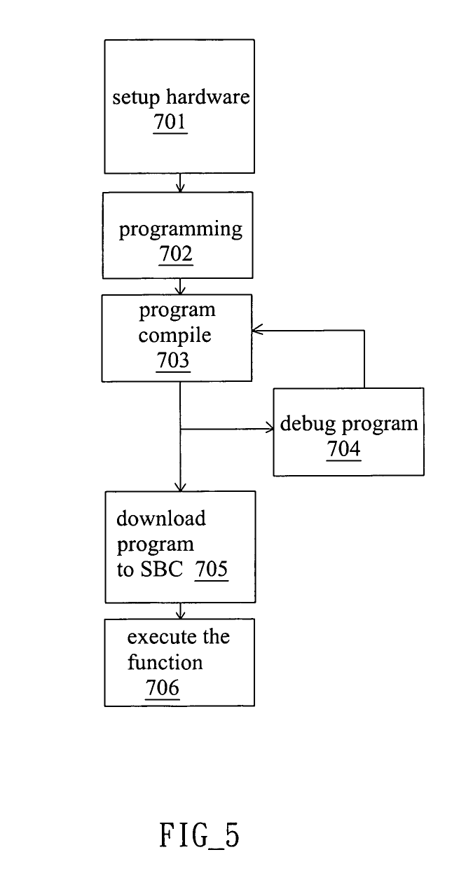

Please referring to FIG. 5, is a flow chart of developing an originative robot. When the product developer would like to develop or build a robot, the first step is to setup the hardware, to connect the SBC and the personal computer via a USB cable and connects all necessary peripheral modules with the SBC by a transmission unit (such as a three-wire command bus), then, to adjust the switch to setup the identification codes of each peripheral module (step 701). Next, to edit simple high-level language command, compile it (step 702 and 703) and debug it until the command or the program passes the compiling process (step 704) on the personal computer. After the program or the command compiled completely, the command will be downloaded to the SBC through the communication interface by a USB cable (step 705), then the slave micro-controller of the corresponding peripheral module executes the commands, controls the peripheral module and completes the commands. Once any urgent or specific events occur, the functional element will send an event signal to notice the SBC through the event line of the transmission unit. After the peripheral module work completely, the event line of the transmission unit will response an event signal to notice the SBC that the peripheral module complete the work, and then, the SBC will access the data of the slave micro-controller of the peripheral module through the data line and the clock line of the transmission unit (step 706).

Although the present invention has been explained in relation to its preferred embodiment, it is to be understood that other modifications and variation can be made without departing the spirit and scope of the invention as hereafter claimed.

What is claimed is:

1. A developing system of re-configurable modularized robot, comprising:
a single board computer, including:
a communication interface, used to receive and transmit a plurality of commands; and
a master micro-controller connecting with said interface to execute said plurality of commands;
a transmission unit connected to said single board computer to transmit said plurality of commands and a plurality of event signals in dual way, wherein said transmission unit is a three-wire data transmission interface; and
at least one peripheral module connecting to said transmission unit, including:
a slave micro-controller, and
a functional element connecting to said slave micro-controller.

2. A developing system of re-configurable modularized robot according to claim 1, wherein said communication interface is a universal serial port and controlled by a universal serial port controller, to control the transmission of said plurality of commands and said plurality of event signals.

3. A developing system of re-configurable modularized robot according to claim 1, wherein said communication interface is anyone of the IEEE 1394, the IR, the peripheral interface bus, and the serial interface bus.

4. A developing system of re-configurable modularized robot according to claim 1, wherein said plurality of commands are high-level language and edited and compiled by a software of a computer, said plurality of commands are downloaded to said master micro-controller via said universal serial port.

5. A developing system of re-configurable modularized robot according to claim 1, wherein said transmission unit is a command bus.

6. A developing system of re-configurable modularized robot according to claim 5, wherein said command bus includes a data line, a clock line, and an event line.

7. A developing system of re-configurable modularized robot according to claim 1, wherein said functional element is an output functional element, and is anyone of the Light Emitting Diode, the Liquid Crystal Display, the Organic Light Emitting Diode, the Vacuum Fluorescent Display and the Seven-Segment Display.

8. A developing system of re-configurable modularized robot according to claim 1, wherein said functional element is an input functional element, and is anyone of the keyboard, the joystick, the knob, the touch panel, and the mouse.

9. A developing system of re-configurable modularized robot according to claim 1, wherein said functional element is a motive power element, and is anyone of the motor, the proportional-integral-derivative, and the servo driver.

10. A developing system of re-configurable modularized robot according to claim 1, wherein said functional element is a network element, and is anyone of the Ethernet, the Web-server, and the X-ten.

11. A developing system of re-configurable modularized robot according to claim 1, wherein said functional element is a storage element, and is anyone of the flash memory, the electrically erasable and programmable read only memory, and the digital security card.

12. A developing system of re-configurable modularized robot according to claim 1, wherein said functional element is a vocal element, and is anyone of the speech element, the voice recognition element, the text-to-speech element, and the synthesizer element.

13. A developing system of re-configurable modularized robot according to claim 1, wherein said functional element is an image element, and is anyone of the image recognition element and the color recognition element.

14. A developing system of re-configurable modularized robot according to claim 1, wherein said functional element is a Fuzzy algorithm element.

15. A developing system of re-configurable modularized robot according to claim 1, wherein said functional element is a communication element, and is anyone of the radio frequency identification element, the infrared element, the radio frequency element, the infrared data association element, the Zigbee element, the RS-232, the I²C, the general packet radio service element, the modem, the universal serial bus, the bluetooth element, the code division multiple access element, the global system for mobile communication element, the RS 422/485, and the telecom.

16. A developing system of re-configurable modularized robot according to claim 1, wherein said functional element is a sensor element, and is anyone of the temperature sensor, the press sensor, the motion sensor, the humidity sensor, the ultrasonic ranger finder, and the IR ranger finder.

17. A developing system of re-configurable modularized robot according to claim 1, wherein said functional element is a navigation element, and is anyone of the global positioning system, the accelerator, the electronic compass element, and the gyro.

18. A developing system of re-configurable modularized robot according to claim 1, wherein said functional element and is anyone of the AM/FM radio element, the relay, the analog to digital converter, and the time piece.

19. A developing system of re-configurable modularized robot according to claim 1, wherein said peripheral module further comprises a switch used to identify the identification code of each said peripheral module.

20. A developing system of re-configurable modularized robot according to claim 1, wherein said plurality of event signals are made from said peripheral module and sent back to said single board computer.
